(19) United States
(12) Patent Application Publication
(10) Pub. No.: US 2008/0160492 A1
(43) Pub. Date: Jul. 3, 2008

(54) INTERACTIVE TRAINING SYSTEM AND METHOD

(75) Inventors: Robert Campbell, Waltham, MA (US); Deborah Cate-Brown, Marshfield, MA (US); Sergey Sirotinin, Pittsburgh, PA (US); John Beck, Cranberry Twp., PA (US)

Correspondence Address: INSULET CORPORATION, 9 Oak Park Drive, Bedford, MA, 01730, US

(73) Assignee: INSULET CORPORATION, Bedford, MA (US)

(21) Appl. No.: 11/835,633

(22) Filed: Aug. 8, 2007

Related U.S. Application Data
(60) Provisional application No. 60/821,754, filed on Aug. 8, 2006.

(51) Int. Cl. G09B 25/00

(52) U.S. Cl. 434/379

(57) ABSTRACT

An interactive training system and method may interactively train or instruct a user on how to use a device, such as a hand-held drug delivery management device. The interactive training system and method may provide one or more interactive tutorials on various aspects or features of the device by displaying a virtual representation of the device and by allowing a user to interact with the virtual representation of the device to simulate use of the device. An interactive tutorial may provide one or more interaction prompts prompting a user to perform one or more steps simulating interaction with the device by activating user controls on the virtual representation and may simulate a response on the virtual representation in response to user activation of the user controls.

### CROSS-REFERENCE TO RELATED APPLICATIONS

This application claims the benefit of U.S. Provisional Patent Application Ser. No. 60/821,754 filed Aug. 8, 2006, which is fully incorporated by reference.

### TECHNICAL FIELD

The present invention relates to systems and methods for providing training or instruction on how to use a device and more particularly, to an interactive training system and method that provides interactive tutorials on the use of a medical device by simulating use of the medical device.

### BACKGROUND INFORMATION

With advances in technology, medical devices are capable of significantly improving the treatment and/or management of various diseases or illnesses. One such medical device is an insulin delivery system capable of delivering insulin to a diabetic individual and managing the delivery of insulin. One example of an insulin delivery system includes an insulin delivery device (e.g., an infusion pump) that is secured to the user to deliver the insulin and a wireless, hand-held device that communicates with the delivery device to control and manage insulin delivery. The hand-held device may program the delivery device with personalized insulin delivery instructions and monitor the operation of the delivery device, thereby facilitating the management of diabetes.

As a result of the many features and capabilities of the hand-held device for managing diabetes and other such medical devices, a user may need to be trained to familiarize the user with the use of the devices and the overall management of the disease or illness. For example, a user should learn how to properly operate and program a hand-held device to control and manage the delivery of insulin (e.g., the basal rates and bolus doses) by an insulin delivery device. Existing training systems use videos to illustrate use of such devices but do not provide effective interactive training for using the devices.

### BRIEF DESCRIPTION OF THE DRAWINGS

These and other features and advantages will be better understood by reading the following detailed description, taken together with the drawings wherein:

FIG. 1 is a diagrammatic view of an interactive training system implemented using a computer system, consistent with one embodiment of the present invention.

FIG. 2 is a diagrammatic view of an interactive training system implemented using a computer system coupled to a network, consistent with another embodiment of the present invention.

FIGS. 3A-3F are screenshots illustrating one example of an interactive tutorial presented by an interactive training system and method, consistent with one embodiment of the present invention.

FIG. 4 is a screenshot illustrating a welcome screen displayed by one embodiment of the interactive training system and method.

FIG. 5 is a screenshot illustrating an overview animation displayed by one embodiment of the interactive training system and method.

FIG. 6 is a flow chart illustrating an interactive training method, consistent with one embodiment of the present invention.

FIG. 7 is a flow chart illustrating another embodiment of an interactive training method.

### DETAILED DESCRIPTION

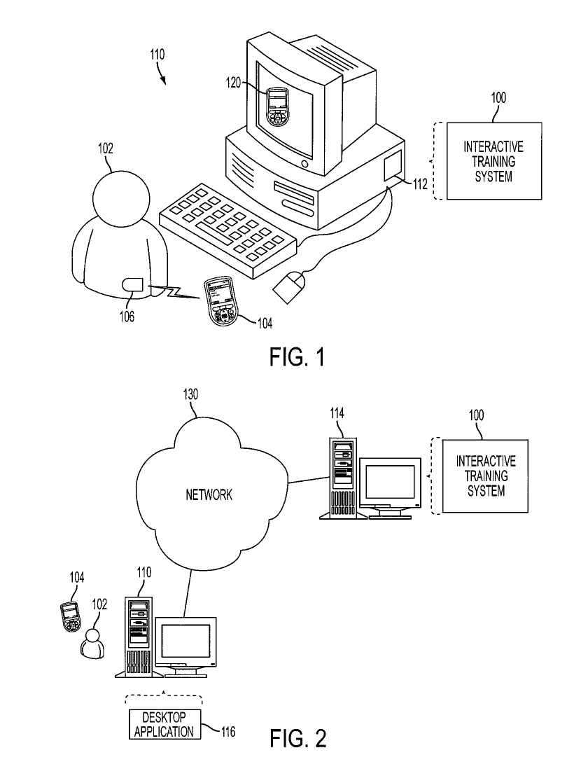

Referring to FIG. 1, an interactive training system and method, consistent with embodiments of the present invention, may interactively train or instruct a user 102 on how to use a hand-held drug delivery management device 104. In the exemplary embodiments, the hand-held drug delivery management device 104 communicates with a drug delivery device 106, such as an insulin infusion pump, to manage delivery of a drug, such as insulin, to a patient or subject. One example of such a drug delivery device 104 and management device 106 is the OmniPod® insulin management system available from Insulet Corporation. The user 102 of the interactive training system and method may be the individual wearing the drug delivery device 106 or may be another individual who is operating the hand-held drug delivery management device 104. Although exemplary embodiments described herein involve insulin delivery, a drug delivery device and management device may be used to deliver of any type of medical substance used to treat or prevent a disease or illness. An interactive training system and method, consistent with embodiments of the present invention, may also be used to provide interactive training for other devices, such as other medical devices.

In one embodiment, an interactive training system 100 may be implemented on a computer system 110, such as a PC, used by the user 102. The computer system 110 displays a virtual representation 120 of the hand-held drug delivery management device 104 to provide one or more tutorials on various aspects or features of the actual hand-held drug delivery management device 104. The tutorials may include steps that are performed in connection with the device 104 (e.g., to use and program the device) and may illustrate the steps using the virtual representation 120 of the device. The tutorials may be interactive such that the user is allowed to interact with the virtual representation 120 to simulate interaction with the actual device 104. The interactive training system 100 may also provide instructions to the user 102, for example to prompt the user to interact with the virtual representation 120. The interactive training system 100 may further provide other information to the user 102, such as general information about the device and/or the disease or illness being treated.

Embodiments of the interactive training system 100 may be implemented as software or a computer program product for use with the computer system 110. Such implementation may include, without limitation, a series of computer instructions that embody all or part of the functionality described herein with respect to the interactive training system and method. The series of computer instructions may be stored in any machine-readable medium, such as semiconductor, magnetic, optical or other memory devices, and may be transmitted using any communications technology, such as optical, infrared, microwave, or other transmission technologies. Such a computer program product may be distributed as a removable machine-readable medium (e.g., a diskette, CD-ROM), preloaded with a computer system (e.g., on system ROM or fixed disk), or distributed from a server or electronic bulletin board over the network (e.g., the Internet or World Wide Web). Alternative embodiments of the invention may be implemented as pre-programmed hardware elements or as a combination of hardware, software and/or firmware.

In the embodiment shown in FIG. 1, the instruction sets and subroutines of the interactive training system 100 may reside on a storage device 112 coupled to the computer system 110 and may be executed by one or more processors (not shown) and one or more memory architectures (not shown) incorporated into the computer system 110. The storage device 112 may be, for example, a hard disk drive, a tape drive, an optical drive, a RAID array, a random access memory (RAM), or a read-only memory (ROM). In one embodiment, the interactive training system 100 may be implemented as one or more executable files and/or objects using a format capable of providing animation and interactivity, such as the format known as Macromedia Flash®. Each of the tutorials provided by the interactive training system 100, for example, may be implemented as a Shockwave Flash® object. Those skilled in the art will recognize that other file formats, authoring programs, and/or programming languages may be used to create a software implementation of the interactive training system 100.

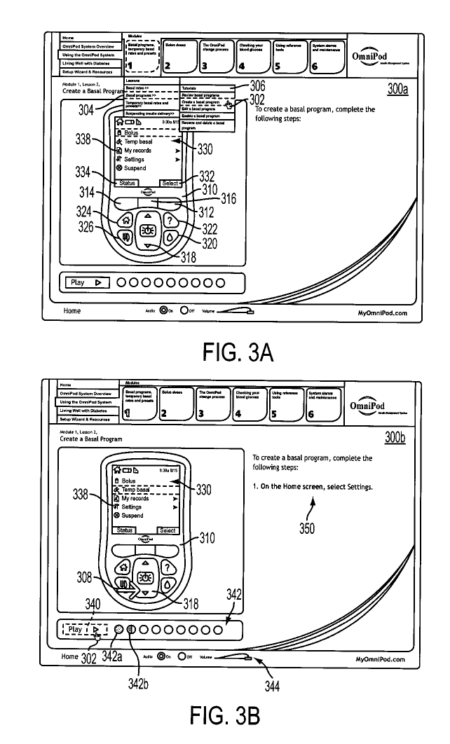

As shown in FIG. 2, the interactive training system 100 may also reside on a separate computer system 114 coupled to a network 130 (e.g., the Internet). The computer system 114 may be a web server running a network operating system, such as Microsoft Windows XP Server™, Novell Netware™, or Redhat Linux™ and may also execute a web server application, such as Microsoft IIS™, Novell Webserver™, or Apache Webserver™, that allows for HTTP (i.e., HyperText Transfer Protocol) access to the computer system 114 via the network 130. In this embodiment, the user 102 may use a desktop application 116 (e.g., Microsoft Internet Explorer™, Netscape Navigator™, or a specialized interface) on the computer system 110 to access the interactive device training system 100 residing on the computer system 114 via the network 130. In this embodiment, at least a portion of the interactive training system 100 may be executed on the computer system 110, for example, as an Active X® control, a Java™ Applet, or a Macromedia Flash® file, as the user 102 uses the interactive training system 100.

According to one embodiment, the interactive training system 100 accessed via the computer system 110 provides tutorials and other information to the user 102 in the form of images, text, animations and/or audio segments. The tutorials presented by the interactive training system 100 may include interactive tutorials that allow user interaction with the virtual representation 120 of a device and non-interactive tutorials that merely demonstrate use of a device using the virtual representation 120. The tutorials presented by the interactive training system 100 may further include informative tutorials that provide information related to the use of the device without displaying the virtual representation 120.

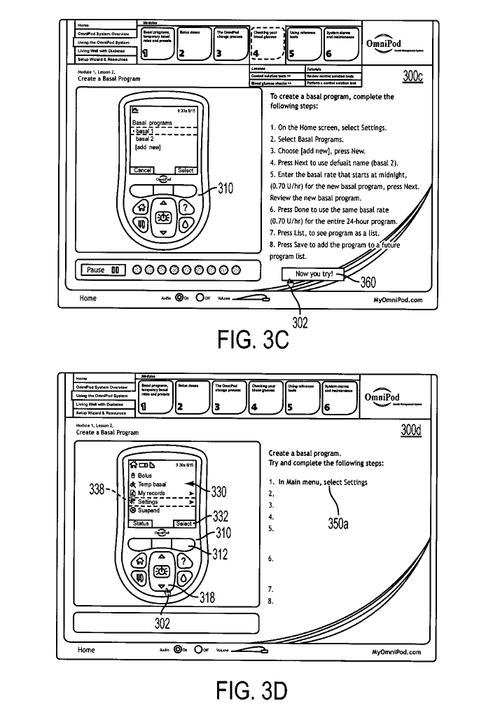

Referring to FIGS. 3A-3F, one embodiment of an interactive training system 100 may generate screens 300a-300f illustrating one example of an interactive tutorial. As shown in FIG. 3A, a screen 300a generated by the exemplary interactive training system may present multiple tutorials (e.g., by displaying tutorial names) for independent selection by a user. In the exemplary embodiment, the tutorials are organized according to categories and sub-categories (e.g., training modules and lessons) and may be selected and initiated through drop down menus 304, 306 using a cursor pointer 302 controlled by the user. The cursor pointer 302 may be controlled, for example, by a user input device such as a mouse coupled to the computer system, which generates a user input signal indicating a location of the cursor pointer 302 relative to the screen 300a. The tutorials may be played, starting with the first tutorial, in the order presented by the interactive training system. A user may also select and initiate any one of the available tutorials at any time without having to view any previous tutorials.

In this example of an interactive training system and method for an insulin management system, training modules may include: 1) basal programs, temporary basal rates and presets; 2) bolus doses; 3) changing the insulin delivery device; 4) checking blood glucose; 5) using reference tools; and 6) system alarms and maintenance. In this example, a first drop down menu 304 may present lessons within a training module and a further drop down menu 506 may present tutorials within a selected lesson. Within Module 1, for example, a user may select the lesson “Basal programs” and may then select the tutorial “Create a basal program.” The illustrated example is merely one example of the topics of the tutorials and is merely one way in which tutorials may be presented to a user of the interactive training system and method. Those skilled in the art will recognize that an interactive training system may present tutorials on various different topics and the tutorials may be organized and presented in various different ways.

The screen 300a generated by the exemplary embodiment of the interactive training system may also include a virtual representation 310 of the hand-held drug delivery management device for which the training is provided. The virtual representation 310 of the hand-held drug delivery management device may include user controls 312-326 on the device and a simulated graphical user interface (GUI) 330 generated by the device. The user controls may include buttons 312, 314, 316 used to activate corresponding functions 332, 334 presented by the GUI 330. The user controls may also include a scroll button 318 used to scroll through items, such as menu items 338, presented by the GUI 330. The user controls may also include dedicated function buttons 320, 322, 324, 326 used to activate dedicated functions, for example, to return to a home screen, to activate a help function, and/or to activate a tools function. A virtual representation of a device being simulated may also include a virtual representation of any other user controls that may be used on the device including, but not limited to, keyboards, joysticks, trackwheels, sliders, toggle switches, and/or touch screens.

A tutorial presented by the exemplary embodiment of the interactive training system may include a series of steps to be performed in connection with the virtual representation 310 of the hand-held drug delivery management device, for example, by activating one or more of the user controls 312-326 on the virtual representation 310. In the illustrated example, the tutorial “Create a basal program” includes the steps that are performed to create a basal program such that an insulin infusion pump will deliver insulin at a programmed basal rate that matches the insulin needs of the individual wearing the insulin infusion pump. An interactive tutorial may include a non-interactive portion and an interactive portion. The non-interactive portion of an interactive tutorial may present (e.g., before the user initiates the interactive portion) an animation demonstrating the steps as they are performed in connection with the virtual representation 310, for example, by showing how the user controls of the device are activated. The interactive portion of the tutorial may provide one or more interaction prompts to the user prompting the user to perform one or more of the steps in connection with the virtual representation 310 and may provide a simulated response to the user actions, thereby simulating interaction with the device. Although the example of the tutorial described herein includes both a non-interactive portion and an interactive portion, an interactive training system and method may also provide interactive tutorials that do not include non-interactive portions and may include non-interactive tutorials that only include non-interactive portions.

As shown in FIG. 3B, screen 300b illustrates a non-interactive portion of a tutorial including an animated sequence of the steps to be performed in connection with the virtual representation 310 of the hand-held drug delivery management device. When the animated sequence is playing, the interactive training system and method may present a textual and/or audio description of the steps while the actions required by the steps are illustrated on the virtual representation 310 of the hand-held drug delivery management device. The actions required by the steps may include activation of one or more of the user controls 312-326 on the virtual representation 310 and the corresponding response on the GUI 330. In the illustrated example, the screen 300b displays text 350 describing the step of “On the Home screen, select Settings” while providing an audio description of the step. At generally the same time, the virtual representation 310 shows the scroll button 318 being activated until the menu item 338 for “Settings” is highlighted on the GUI 330. The screen 300b may also indicate the user control (e.g., scroll button 318) that is activated to perform the specified step, for example, using an arrow 308 or by highlighting the user control with a different color while it is activated. Each of the steps may be identified and demonstrated in this way, and the animated sequence may continue until all of the steps associated with the tutorial have been identified and demonstrated on the virtual representation 310.

The screen 300b may also include controls for controlling the animation. The controls may include a play/pause button 340 to control playing and pausing of the animated sequence and a playback controller 342 to indicate progress of the animated sequence and to control playback. The playback controller 342 may include separate playback indicators 342a, 342b corresponding to the steps being illustrated. In the illustrated example, a first playback indicator 342a may correspond to an introduction of the tutorial, a second playback indicator 342b may correspond to the text 350 describing a first step, and so forth. A user may thus select one of the playback indicators 342a, 342b to jump to a desired location in the animated sequence corresponding to one of the steps. The playback indicators 342a, 342b may also include numbers or other alpha-numeric identifiers corresponding to the associated step. The numbers (or other alpha-numeric identifiers) may appear on the playback indicators 342a, 342b when the cursor pointer 302 passes over the respective playback indicators 342a, 342b or may appear continuously on the playback indicators 342a, 342b. Audio controls 344 may also be provided, for example, to turn the audio on and off and to control volume.

After the non-interactive portion of a tutorial is completed (e.g., all of the steps have been demonstrated), the exemplary interactive training system may provide the user with the option of initiating an interactive portion of the tutorial. As shown in FIG. 3C, for example, the screen 300c displays a “Now you try!” button 360, which may be selected with the cursor pointer 302. The tutorial may also proceed directly to the interactive portion without receiving user input. Although the illustrated embodiment shows the non-interactive portion played before the interactive portion of the tutorial, an interactive tutorial may be initiated without the non-interactive portion or with the non-interactive portion of the tutorial played at another time.

If a user initiates an interactive portion of a tutorial (e.g., using the “Now you try!” button 360), the exemplary training system allows the user to interact with the virtual representation 310 of the hand-held drug delivery device to simulate use of the device in accordance with the steps of the tutorial. As shown in FIGS. 3D-3F, screens 300d-300f illustrate some of the steps in the interactive portion of the exemplary tutorial. During the interactive portion of a tutorial, the interactive training system may provide the user with one or more interaction prompts prompting the user to perform one or more steps relative to the virtual representation 310 of the device. An interaction prompt may include a text prompt 350a and/or an audio prompt instructing a user to perform a step. The steps to be performed may include activating one or more of the user controls 312-326 on the virtual representation 310, for example, as demonstrated in the non-interactive portion of the tutorial. The steps to be performed in the interactive portion of a tutorial may include the same steps performed in a non-interactive portion of the tutorial or may include different steps requiring different activation of the user controls.

To activate the user controls required to perform the step identified by an interaction prompt, the user may manipulate the cursor pointer 302 to select locations on the virtual representation 310 corresponding to the user controls. A user input device that controls the cursor pointer 302, for example, may provide a user input signal indicating a location of the cursor pointer 302. The interactive training system may receive the user input signal and determine if the user has selected a location corresponding to a user control. When the user activates the user control buttons on the virtual representation 310, the virtual representation 310 provides a simulated response, for example, on the GUI 330. The interactive training system may also provide an indication of when a user control is activated, for example, by changing the color of the user control button on the virtual representation 310 when the user “clicks” on the button (see FIG. 3E). The interactive training system may also provide simulated audio responses (e.g., “beeps” or “clicks”) when the user control buttons are activated.

To perform a step, the user may be required to activate a sequence of the user control buttons resulting in a sequence of simulated responses. In the screen 300d, for example, to perform the step “In Main menu, select Settings,” the user should move the cursor pointer 302 to the scroll button 318 and activate the scroll button 318 (e.g., by clicking) causing the GUI 330 to simulate a response of scrolling through menu items until the “Settings” menu item 338 is selected. The user should then move the cursor pointer 302 to the button 312 to activate the “Select” function 332 on the GUI 330. As shown in FIG. 3E, screen 300e illustrates that the GUI 330 responds accordingly by displaying a “Settings” menu.

After providing an interaction prompt to perform a step, the interactive training system may pause to receive user activations of the user controls on the virtual representation 310. When the interactive training system receives the user activations, the interactive training system may determine if the user activations correspond to the user activations required to complete the step. If the user successfully completes a step after performing one or more activations of the user control buttons, the interactive training system may provide the user with an indication that the step has been successfully completed. The indication of successful completion of a step may include providing the next interaction prompt. The indication of successful completion of a step may also include a textual and/or audio notification of successful completion of a step. If the user does not activate the proper user controls to complete a step successfully, the interactive training system may provide an indication that the user has not activated the proper user controls. The interactive training system also may continue to pause and may not provide the next interaction prompt until the user has successfully completed a step.

In the screen 300e, for example, the interactive training system and method is paused until the user successfully completes the second step “Select Basal Programs.” If the user successfully completes the step by using the scroll button 318 to scroll to the “Basal Programs” menu item 338 and by using the button 312 to activate the “Select” function 332, the interactive training system may play an audio message indicating successful completion of the step (e.g., “That's correct”). The interactive training system may then display a text prompt for a third step. If the user selects the menu item “Presets” or activates the button 316, for example, the interactive training system may indicate that the step has not been completed, for example, by playing an audio message “Sorry, try another selection.”

After the user has successfully completed all of the prompted steps associated with a tutorial, the interactive training system may provide a notification that the tutorial has been successfully completed. As shown in FIG. 3F, for example, the screen 300f illustrates that seven steps have been completed and the user is prompted to perform an eighth (and final) step, namely, “Press Save to add the program to a basal program list.” After receiving this prompt, the user may then activate the button 316 to select the “Save” function 336 on the GUI 330. If this final step is successfully completed, the interactive training system may provide a notification of successful completion, for example, using an audio message stating “Congratulations! You have successfully completed this tutorial.” After successful completion of a tutorial, the interactive training system may then provide the user with an option to play the next tutorial or to replay the tutorial.

Embodiments of the interactive training system may further provide additional guidance or tips (e.g., in the form of audio messages) during an interactive tutorial to assist the user in activating the proper user controls to complete a step. The interactive training system may further assist a user in completing a step in an interactive tutorial by demonstrating the proper activation of user controls to complete the step (similar to the non-interactive tutorial). Demonstration of a step may be provided in response to the user's request for help or in response to a predetermined time or predetermined number of failed attempts at completing a step.

In another embodiment of a tutorial, the interactive training system may provide a plurality of interaction prompts without pausing or waiting for the user to perform the steps identified by the interaction prompts. For example, all of the textual prompts may be displayed on the screen before the user begins activating the user controls on the virtual representation 310 to perform the steps. In this embodiment, the interactive training system may provide an indication of when a step has been successfully performed, for example, by using an audio message or by highlighting or changing the color of the text used to provide the prompts. In a further embodiment of a tutorial, the interactive training system may pause after providing an interaction prompt and may automatically proceed to a subsequent interaction prompt after a predetermined time or a predetermined number of failed attempts at successfully completing a step.

In yet another embodiment of a tutorial, the interactive training system may provide one or more prompts that prompt a user to perform multiple steps. According to this embodiment, a tutorial may provide an interactive quiz. According to an interactive quiz on creating a basal program, for example, an interaction prompt may prompt the user to create a basal program having specified parameters (e.g., a basal rate) without providing prompts or instructions for each of the steps necessary to create the basal program. The interactive training system may provide a notification to the user if the user successfully completes the steps necessary to create the basal program with the specified parameters.

One exemplary embodiment of the interactive training system may provide a number of different tutorials related to using an insulin management system. These tutorials are organized according to modules and lessons and may include interactive tutorials involving user interaction with a virtual representation of a personal diabetes manager, non-interactive tutorials demonstrating interaction with the virtual representation, and informative tutorials providing information related to the system or to diabetes management in general without use of the virtual representation. A lesson on “Basal programs,” for example, may include an informative tutorial “Review basal programs” to review the concept of a basal program and then interactive tutorials (e.g., “Create a basal program”) including a non-interactive portion and an interactive portion, as described above. Examples of the tutorials related to using an insulin management system include, but are not limited to:

### Module 1—Basal Programs, Temporary Basal Rates and Presets

### Basal Rates Lesson

Tutorials: Review basal rates

### Basal Programs Lesson

Tutorials: Review basal programs; Create a basal program; Edit a basal program; Enable a basal program; Rename and delete a basal program

### Temporary Basal Rates and Presets Lesson

Tutorials: Review temporary basal rates and presets; Enable and cancel a one-time temporary basal rate; Create a temporary basal preset; Enable and cancel a temporary basal preset; Edit and rename a temporary basal preset; Edit a maximum basal rate setting

### Suspending Insulin Delivery

Tutorials: Review suspending insulin delivery; Suspend insulin delivery; Resume insulin delivery

### Module 2—Bolus Doses

### Bolus Doses

Tutorials: Review bolus doses;

### Normal and Extended Bolus Delivery

Tutorials: Review normal and extended bolus delivery, Deliver a normal bolus manually, Deliver an extended bolus

### Suggested Bolus Calculation

Tutorials: Review suggested bolus calculation; Set personal setting for suggested bolus calculation; Calculate and deliver suggested bolus

### Bolus Presets

Tutorials: Review bolus presets; Create a bolus preset; Enable and cancel a bolus preset;

Edit a bolus preset

### Active Bolus Cancellation

Tutorials: Cancel an active bolus

### Module 3—Changing the Insulin Delivery Device

Tutorials: Review the change process; Deactivate and remove the insulin delivery device;

Fill a new device with insulin; Select and prepare an infusion site; Attach the device and begin insulin delivery; Check the device status

### Module 4—Checking Blood Glucose

### Control Solution Tests

Tutorials: Review control solution tests; Perform a control solution test

### Blood Glucose Checks

Tutorials: Review blood glucose checks; Prepare the lancing device; Prepare the test strip; Lance your finger; Lance your hand, forearm, upper arm, thigh, or calf; Obtain a blood glucose reading; Remove the lancet

### Module 5—Using Reference Tools

### The Reference Food Library

Tutorials: Access the reference food library

### Record Keeping

Tutorials: Review record keeping; View insulin delivery history; View blood glucose history; View alarm history; View carbohydrate history; View all history records

### Module 6—System Alarms and Maintenance

### Errors, Advisories, and Hazard Alarms

Tutorials: Review errors, advisories, and hazard alarms; Blood glucose meter error messages; Advisory alarms; Hazard alarms ps Communication Failures

Tutorials: Review communication failures; Communication failures at start-up;

Communication failures during operation; Communication failures during bolus cancellation

### Optional Alerts and Reminders

Tutorials: Review optional alerts and reminders; Set a missed bolus reminder and low reservoir alert

### Basic Maintenance

Tutorials: Replacing PDM batteries; Care for your personal diabetes manager; Care for your insulin delivery device; Ordering Supplies

The exemplary embodiment of the interactive training system may also provide a number of different tutorials related to the setup of an insulin delivery management device and other resources. Examples of these tutorials include, but are not limited to:

### Module 1—The Setup Wizard

Tutorial: Program your Personal Diabetes Manager using the Setup Wizard

### Module 2—Useful Forms and Documents

Tutorial: Review forms and documents

### Module 3—Interactive Quiz

Tutorial: Take the interactive quiz

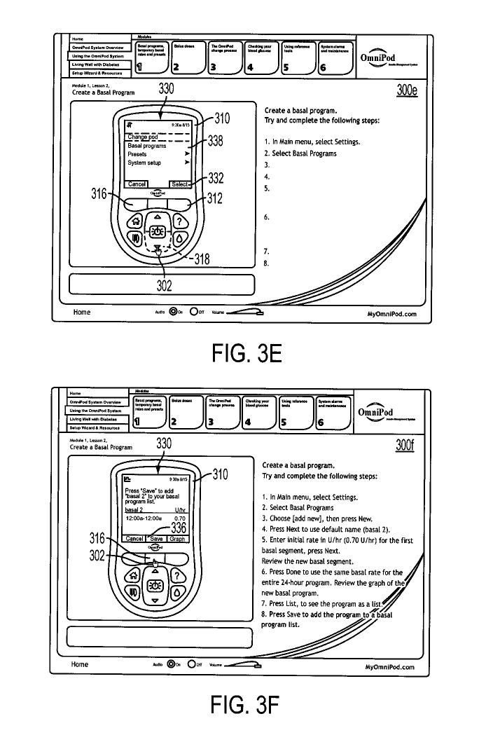

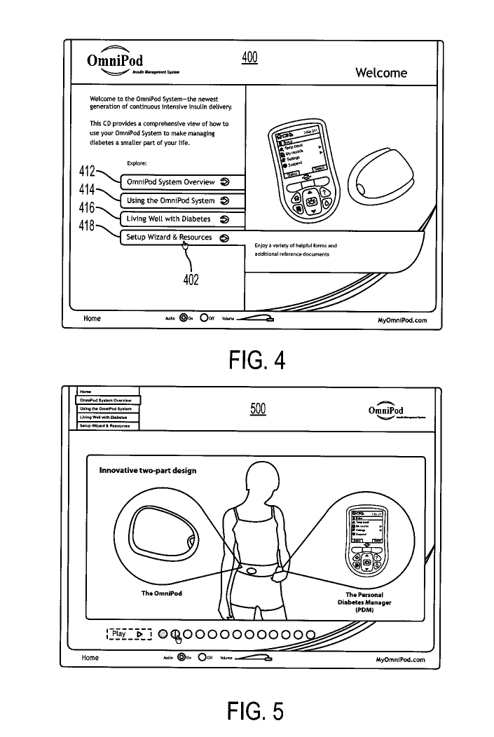

Referring to FIGS. 4-5, the training system and method, consistent with embodiments of the present invention, may also display other screens 400, 500 for use in providing information to a user of the device for which tutorials are provided. A welcome screen 400, for example, may be displayed when the interactive training system is executed by the user. The welcome screen 400 may identify different categories 412, 414, 416, 418 of tutorials or information that may be provided by the interactive training system. A cursor pointer 402 may be used to select one of the categories 412, 414, 416, 418 to access the tutorials or information associated with those categories. In addition to displaying text describing the categories 412, 414, 416, 418, the interactive training system may also provide audio descriptions of the categories, for example, when the cursor pointer 402 passes over the categories 412, 414, 416, 418.

In addition to tutorials specific to the device, the interactive training system may provide other information to users of the medical device for which tutorials are provided. The exemplary screen 500, for example, provides an animated sequence describing an overview of an insulin delivery device and hand-held insulin delivery management device. The animated sequence may include a sequence of images and/or animations with or without accompanying audio describing the topic. Other information that may be provided may include information on the disease or illness being treated by the medical device (e.g., information on living with diabetes). Such information may also be provided using other techniques such as a movie clip, slide show, or audio without any images.

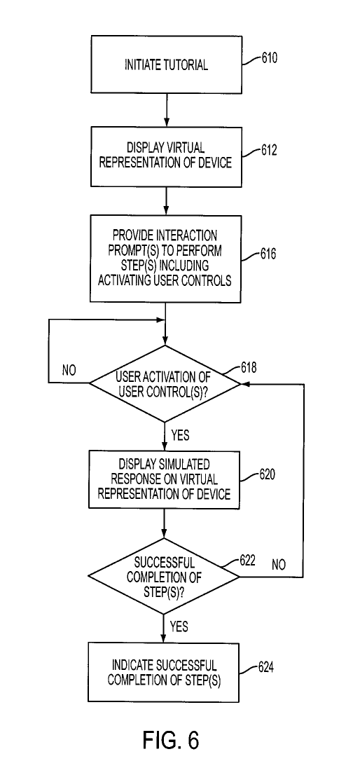

FIG. 6 illustrates one embodiment of an interactive training method that may be used to interactively train a user to use a hand-held drug delivery management device. This embodiment of the interactive training method includes initiating 610 a tutorial, for example, in response to a user selection of the tutorial from a plurality of tutorial options presented to the user. As described in the examples above, the tutorial may include a plurality of steps simulating interaction with the drug delivery management device. This embodiment of the interactive training method also includes displaying 612 a virtual representation of the hand-held drug delivery management device, for example, on the display of the computer system used to perform the interactive training method. As described above, the virtual representation of the device may include user controls on the device and a GUI provided by the device.

This embodiment of the interactive training method further includes providing 616 one or more interaction prompts to the user prompting the user to perform one or more steps simulating interaction with the device. The steps may require activation of one or more user controls on the virtual representation of the device. As described in the examples above, multiple interaction prompts may be provided with a pause after each prompt to wait for a user response, or one or more interaction prompts may be provided at once to be followed by a series of steps. After providing one or more interaction prompts, this embodiment of the interactive training method includes determining 618 if the user has activated one or more user controls on the virtual representation of the device. As described in the examples above, the method may determine that a user has activated one or more user controls if a user input signal generated by a user input device indicates that a cursor pointer has selected a location on the virtual representation corresponding to the user control(s). In response to user activation of user control(s), this embodiment of the interactive training method displays a simulated response on the GUI of the virtual representation of the device. As described in the examples above, the simulated response on the GUI of the virtual representation of the device simulates the response that would be provided by the actual device if the user control(s) were activated.

This embodiment of the interactive training method may also include determining 622 if one or more steps have been successfully completed as a result of user activation of the user control(s). This determination may be made by comparing the user activations with predetermined user activations needed to complete the step(s). If one or more steps have been successfully completed, this embodiment of the interactive training method may further including indicating 624 successful completion of the one or more steps. Indication of successful completion of a step may include proceeding to a subsequent prompt after the successful completion of the step. Indication of successful completion of one or more steps may also include a textual and/or audio notification for each step or for a plurality of steps.

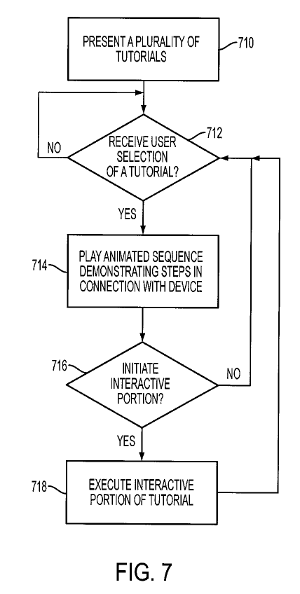

FIG. 7 illustrates another embodiment of an interactive training method that may be used to interactively train a user to use a hand-held drug delivery management device. This embodiment of the interactive training method includes presenting 710 a plurality of tutorials to a user, for example, by displaying a plurality of tutorial names on a screen. If a user selection of one of the tutorials is received 712, this embodiment of the interactive training method plays 714 an animated sequence demonstrating steps that are performed in connection with the device for the selected tutorial. After playing the animated sequence, the user is given the option of initiating an interactive portion of the tutorial that simulates interaction with the device in the manner demonstrated by the animated sequence. If the interactive portion is initiated 716, this embodiment of the interactive training method may execute 718 the interactive portion of the tutorial, for example, according to the various embodiments described above.

Accordingly, embodiments of the present invention may be used to provide interactive training for using a hand-held drug delivery management device. Consistent with one embodiment of the present invention, a method for interactively training a user includes initiating at least one tutorial on using at least one feature of the hand-held drug delivery management device. The tutorial includes steps simulating interaction with the hand-held drug delivery management device. The method also includes displaying a virtual representation of the hand-held drug delivery management device. The virtual representation includes user controls on the hand-held drug delivery management device and a graphical user interface provided by the hand-held drug delivery management device. The method further includes providing at least one interaction prompt to a user prompting the user to perform at least one of the steps simulating interaction with the hand-held drug delivery management device. Performing at least one of the steps includes activating at least one of the user controls on the virtual representation of the hand-held drug delivery management device. The method further includes displaying a simulated response on the graphical user interface of the virtual representation of the hand-held drug delivery management device in response to user activation of the at least one of the user controls on the virtual representation.

Consistent with another embodiment of the present invention, a method of interactively simulating use of a medical device includes displaying a virtual representation of the medical device. The virtual representation includes user controls on the medical device. The method also includes providing at least one interaction prompt to a user prompting the user to perform at least one step simulating interaction with the medical device. Performing the step includes activating at least one of the user controls on the virtual representation of the medical device. The method further includes displaying a simulated response of the medical device on the virtual representation of the medical device in response to user activation of the at least one of the user controls on the virtual representation of the medical device.

Consistent with a further embodiment of the present invention, a machine readable medium may include contents that cause a computer system to perform the methods described above. Consistent with yet another embodiment of the present invention, a system may include one or more computer systems programmed to perform the methods described above.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A method for interactively training a user to use a hand-held drug delivery management device, the method comprising:
initiating at least one tutorial on using at least one feature of the hand-held drug delivery management device, the tutorial including steps simulating interaction with the hand-held drug delivery management device;
displaying a virtual representation of the hand-held drug delivery management device, the virtual representation including user controls on the hand-held drug delivery management device and a graphical user interface provided by the hand-held drug delivery management device;
providing at least one interaction prompt to a user prompting the user to perform at least one of the steps simulating interaction with the hand-held drug delivery management device, wherein performing at least one of the steps includes activating at least one of the user controls on the virtual representation of the hand-held drug delivery management device; and
in response to user activation of the at least one of the user controls on the virtual representation of the hand-held drug delivery management device, displaying a simulated response on the graphical user interface of the virtual representation of the hand-held drug delivery management device.

2. The method of claim 1 further comprising:
after providing each of a plurality of interaction prompts, pausing to receive the user activation of the at least one of the user controls before providing a subsequent interaction prompt; and
in response to receiving user activation following a respective one of the interaction prompts, providing the subsequent interaction prompt if the user successfully completed the step associated with the respective one of the interaction prompts.

3. The method of claim 1 further comprising:
upon successful completion of all of the steps associated with the tutorial, providing a notification of successful completion.

4. The method of claim 1 further comprising:
in response to user activation of the at least one of the user controls associated with a respective one of the steps, providing a notification that the user successfully completed the respective one of the steps.

5. The method of claim 4 further comprising:
in response to user activation of user controls that are not associated with a respective one of the steps, providing a notification that the user has not successfully completed the respective one of the steps.

6. The method of claim 1 wherein the hand-held drug delivery management device is configured to communicate with an insulin delivery device to manage delivery of insulin to a subject wearing the insulin delivery device.

7. The method of claim 1 wherein providing the at least one interaction prompt includes displaying at least one text prompt.

8. The method of claim 1 wherein providing the at least one interaction prompt includes playing at least one audio prompt.

9. The method of claim 1 wherein the user activation is provided by a user input signal generated by a user input device that controls a cursor to select a location on the virtual representation of the hand-held drug delivery management device displayed by a computer system.

10. The method of claim 9 further comprising:
in response to receiving a user input signal selecting a location corresponding to one of the user controls on the hand-held drug delivery management device, displaying an indication on the virtual representation indicating that one of the user controls on the hand-held drug delivery management device is activated.

11. The method of claim 1 further comprising:
prior to providing the at least one interaction prompt to the user, playing an animated sequence demonstrating the steps associated with the tutorial.

12. The method of claim 11 further comprising:
displaying text describing the steps as the steps are performed in the animated sequence.

13. The method of claim 12 further comprising:
providing a playback controller to indicate progress of the animated sequence and to control playback of the animated sequence, the playback controller including step playback indicators associated with respective ones of the steps; and
in response to a user selection of one of the step playback indicators, playing the animated sequence at a location corresponding to the step associated with the selected step playback indicator.

14. The method of claim 1 further comprising:
displaying a plurality of tutorial names associated with a plurality of tutorials for using features of the hand-held drug delivery management device, wherein a tutorial is initiated in response to receiving a user selection of one of the tutorials.

15. A machine-readable medium whose contents cause a computer system to perform a method for interactively training a user to use a hand-held drug delivery management device, the method comprising:
initiating at least one tutorial on using at least one feature of the hand-held drug delivery management device, the tutorial including steps simulating interaction with the hand-held drug delivery management device;
displaying a virtual representation of the hand-held drug delivery management device, the virtual representation including user controls on the hand-held drug delivery management device and a graphical user interface provided by the hand-held drug delivery management device;
providing at least one interaction prompt to a user prompting the user to perform at least one of the steps simulating interaction with the hand-held drug delivery management device, wherein performing at least one of the steps includes activating at least one of the user controls on the virtual representation of the hand-held drug delivery management device; and
in response to user activation of the at least one of the user controls on the virtual representation of the hand-held drug delivery management device, displaying a simulated response on the graphical user interface of the virtual representation of the hand-held drug delivery management device.

16. The machine-readable medium of claim 15 wherein the method further comprises:
after providing each of a plurality of interaction prompts, pausing to receive the user activation of the at least one of the user controls before providing a subsequent interaction prompt; and
in response to receiving user activation following a respective one of the interaction prompts, providing the subsequent interaction prompt if the user successfully completed the step associated with the respective one of the interaction prompts.

17. The machine-readable medium of claim 15 wherein the method further comprises:
prior to providing the interaction prompts to the user, playing an animated sequence demonstrating the steps associated with the tutorial.

18. A system for interactively training a user to use a hand-held drug delivery management device, the system comprising:
means for initiating at least one tutorial on using at least one feature of the hand-held drug delivery management device, the tutorial including steps simulating interaction with the hand-held drug delivery management device;
means for displaying a virtual representation of the hand-held drug delivery management device, the virtual representation including user controls on the hand-held drug delivery management device and a graphical user interface provided by the hand-held drug delivery management device;
means for providing at least one interaction prompt to a user prompting the user to perform at least one of the steps simulating interaction with the hand-held drug delivery management device, wherein performing at least one of the steps includes activating at least one of the user controls on the virtual representation of the hand-held drug delivery management device; and
means for displaying a simulated response on the graphical user interface of the virtual representation of the hand-held drug delivery management device in response to user activation of the at least one of the user controls on the virtual representation of the hand-held drug delivery management device.

19. A method of interactively simulating use of a medical device, the method comprising:
displaying a virtual representation of the medical device, the virtual representation including user controls on the medical device;
providing at least one interaction prompt to a user prompting the user to perform at least one step simulating interaction with the medical device, wherein performing the step includes activating at least one of the user controls on the virtual representation of the medical device; and
in response to user activation of the at least one of the user controls on the virtual representation of the medical device, displaying a simulated response of the medical device on the virtual representation of the medical device.

20. The method of claim 19 further comprising initiating a tutorial including a plurality of steps simulating interaction with the medical device.
